(19) United States
(12) Patent Application Publication
(10) Pub. No.: US 2010/0058573 A1
(43) Pub. Date: Mar. 11, 2010

(54) USE OF BARRIER FILM FOR PARTS LUBRICATION IN HUB TO SHAFT PRESS FIT OPERATION

(75) Inventors: Sheth Champaklal Sanjay, Sunnyvale, CA (US); Gordon Alan Kashiwagi, San Jose, CA (US); James Scott Bowdoin, Aptos, CA (US)

Correspondence Address: SEAGATE TECHNOLOGY LLC;C/O NOVAK DRUCE & QUIGG LLP, 1000 LOUISIANA, Fifty-Third Floor, HOUSTON, TX, 77002, US

(73) Assignee: Seagate Technology LLC, Scotts Valley, CA (US)

(21) Appl. No.: 12/209,181

(22) Filed: Sep. 11, 2008

(51) Int. Cl. B23P 11/00

(52) U.S. Cl. 29/505

(57) ABSTRACT

Methods or devices are provided to press fit operations using barrier film to lubricate parts or components of an assembly. Embodiments are capable of eliminating current common problems in press fit operations and related fields including the contamination of adjacent parts with oils or other lubricating fluids, the requirement of excessive and damaging Press Forces, and the presence of pronounced Force/Displacement “ripple” or “chatter.” Embodiments allow for a barrier film to act in place of a lubricant during the hub-shaft press operation, but require no press operator application or clean-off after pressing.

### BACKGROUND

1. Field of Invention

The present invention relates to the formation of press fit assemblies and to press fit operations, and in particular to new methods and devices of press-fit assemblies, and new lubricant substitutes for press fit operations.

2. Description of the Background

A press fit, sometimes called an interference fit, is a fastening between two parts or components typically achieved by friction after the parts are pushed together, rather than by any other means of fastening. For metal parts in particular, the friction that holds the parts together is often greatly increased by compression of one part against the other, which relies on the tensile and compressive strengths of the materials from which the parts are made. Examples include the press fitting of shafts into bearings or bearings into their housings and the attachment of watertight connectors to cables. Generally, the two parts to be joined consist of one referred to as a “male” part and the other referred to as a “female” part.

Manufacturing parts which must be pressed together is preferable when a certain amount of retention strength between the joined parts is desired. Retention strength may be defined as the amount of force required to pull the parts apart from each other after the parts have been joined. Retention strength may be desired to ensure that the joined parts remain in contact with each other while the combined unit is subjected to external forces.

If the load required to press the parts together is too great, the parts may become deformed or the press machine may be damaged during the press fit operation. As a result of a large load requirement, the press machine may vibrate and cause the parts to join in a choppy and/or surging motion which makes it difficult to precisely press the male part into a desired position relative to the female part.

One solution to such problems involves lubricating the parts with oil or alcohol prior to pressing them together. However, oil is not always a suitable lubricant because it can contaminate adjacent parts. Although barrier film has not been used as a lubricant, it has, nonetheless, been used to prevent migration of fluids such as oil to locations where oil would contaminate adjacent parts. When used to prevent migration of oils, fluids or other lubricants, barrier film has been placed on the tapered part or intermediate part of the shaft and not on the press-fit section. This has typically resulted in high press forces being required to press fit the parts. Lubricants in the form of a grease are also not helpful because they are too thick for fine press fits.

Although alcohol is much less likely than oil to contaminate adjacent parts (primarily due to the fact that alcohol evaporates from the parts shortly after being applied), alcohol's ability to function as a lubricant is inferior to that of oil and results in choppiness, or “ripple.” Ripple constitutes pronounced vacillation in the press force due to jerky motion of the hub on the shaft, and is undesirable because it exerts excessive stress on the press and can therefore damage various parts of the press including the shaft. Furthermore, ripple causes difficulty in pressing the parts to a prescribed or desired height or position due to the surging motion during the operation, preventing the setting of the height axially with precision.

In the disc drive field, fluid dynamic bearings have been used as a cheap solution for lubrication between a spindle and a hub, replacing the more conventional ball bearing drive systems. See LeBlanc et al. Publication No. US 20060291757. Fluid bearings use a thin layer of liquid or gas fluid between the bearing faces, typically sealed around or under the rotating hub or shaft. In fluid-dynamic bearings, the bearing rotation sucks the fluid on to the inner surface of the bearing, forming a lubricating wedge under or around the shaft and supporting the bearing's loads on a thin layer of liquid. Fluid bearings are effective in high load, high speed or high precision applications where ordinary ball bearings have a short life or high noise and vibration.

Such bearings are typical of the journal and thrust types. Journal bearings fix the radial position of the hub as it rotates around the spindle. Thrust bearings constrain the axial position of the hub as it rotates. One, or the other, or both mating hub and spindle surfaces can be patterned with grooves and lands in various patterns to make lubricant fluid pumps that are actuated by the rotation of the hub relative to the spindle. Such pumps can maintain lubricant fluid pressure gradients while the hub is rotating, providing thrust and journal bearing functions. When the hub is not rotating, lubricant fluids are maintained in place in the hub to spindle gap by capillary forces.

For disc drives having first and second covers mounted to the spindle for improved mechanical stability, lubricant fluid loss is inevitable at both termini of the spindle, and is an operational lifetime limiting factor for such disc drives. Sealing techniques include capillary seals and labyrinth seals. See Price et al., U.S. Pat. No. 6,679,632. Capillary seals are flared channels that rely on the surface tension of the lubricant fluid to form a meniscus as the walls of a channel flare apart. Capillary seals can also serve as reservoirs for lubricant fluid, but they are prone to lubricant loss through evaporation at the surface of the meniscus. Labyrinth seals can be used with capillary seals to further reduce lubricant evaporation by providing an elongated pathway for lubricant vapor to escape. Unfortunately, effective labyrinth seals tend to consume a fair amount of space, and are therefore difficult to use at both ends of a spindle. Different seal designs can be used at each end of a spindle. However, this not an optimal solution because it is important for the lubricant fluid pressures at the first and second seals to be at nearly the same pressure to reduce the loss of lubricant fluid from the seal with the lower pressure, and equivalent pressure is difficult to achieve using different seal designs at each end of the spindle.

### SUMMARY

The present invention overcomes problems and disadvantages associated with current strategies and designs in press fitting, and provides methods and devices for press fit operations using barrier film as a substitute for lubricants for parts or components of an assembly.

One embodiment of the present invention is directed to a method of securely joining components of a press fit assembly comprising: applying a surface altering agent to a surface area of a first component that is to be placed in contact with a second surface area of a second component within the press fit assembly, and wherein the surface altering agent forms a barrier film; and pressing the surface area containing the barrier film into contact with the second surface area. In another embodiment, the barrier film forming comprises applying the surface altering agent in a liquid form to the first surface area; and drying the liquid form surface altering agent at room temperature. In another embodiment, the barrier film forming comprises applying the surface altering agent in a liquid form to the first surface area; and drying the liquid form surface altering agent at a temperature which can vary widely, but is preferably of greater than 25° C., more preferably greater than 40° C., more preferably greater than 60° C., more preferably greater than 80° C., more preferably greater than 95° C., and more preferably greater than 100° C.

Another embodiment is directed to a method according to certain embodiments of the invention, wherein the surface altering agent fills capillaries of the surface area to which it is applied. Another embodiment is directed to a method, wherein the surface altering agent prevents wetting of the surface area to which it is applied.

Another embodiment is directed to a method according to certain embodiments of the invention, wherein the components comprise a hub and a shaft.

Another embodiment is directed to a method wherein the surface altering agent comprises a fluorocarbon coating.

Another embodiment is directed to a method according to certain embodiments of the invention, wherein the surface altering agent comprises a fluorochemical acrylate polymer coating carried in a hydrofluoroether solvent. In another embodiment, the hydrofluoroether solvent evaporates.

Another embodiment is directed to a method according to certain embodiments of the invention, wherein the surface altering agent comprises fluorocarbon, a fluorochemical acrylate polymer substance, a hydrofluoroether solvent, polyethylene, polytetrafluoroethylene, polyvinylidene chloride, polyvinylidene fluoride, ethylene-vinyl alcohol copolymer, metals, aluminum, silicon oxide or silicon dioxide, ethylene, chlorotrifluoroethylene copolymer, polychlorotrifluoroethylene polymer, or a combination thereof.

Another embodiment is directed to a method according to certain embodiments of the invention, wherein the barrier film repels fluids, air or gases. In certain embodiments, the fluids comprise lubricating oils, silicones, hydrocarbon oils, silicone oils, synthetic fluids, aqueous solutions, heptane, toluene, water or combinations thereof. Another embodiment is directed to a method wherein the fluids bead and drain from the surface area to which the barrier film is applied.

Another embodiment is directed to a method according to certain embodiments of the invention, wherein the barrier film is insoluble in heptane, toluene, water, or combinations thereof.

Another embodiment is directed to a method according to certain embodiments of the invention, wherein the barrier film is strippable with fluorinated solvents.

Another embodiment is directed to a method according to certain embodiments of the invention, wherein the barrier film is transparent.

Another embodiment is directed to a method according to certain embodiments of the invention, wherein the barrier film has a refractive index of 1.5 or less.

Another embodiment is directed to a method according to certain embodiments of the invention, wherein the barrier film has minimal or low toxicity.

Another embodiment is directed to a method according to certain embodiments of the invention, wherein the barrier film has a soft modulus of elasticity or flexibility.

Another embodiment is directed to a method according to certain embodiments of the invention, wherein the barrier film has a surface energy that may vary but preferably has a surface energy of less than 35 dynes/cm, more preferably 12 dynes/cm or less, and more preferably of 11 dynes/cm or less.

Another embodiment is directed to a method according to certain embodiments of the invention, wherein the thickness of the barrier film may vary but preferably has a thickness of less than 0.2 microns, and more preferably has a thickness of less than 0.1 micron.

Another embodiment is directed to a method according to certain embodiments of the invention, wherein one or more of the components are metal. Another embodiment is directed to a method according to certain embodiments of the invention, wherein one or more of the components are copper, aluminum, ceramic, steel, tin, glass, or combinations thereof.

Another embodiment is directed to a method further comprising heating the barrier film before pressing the parts together. Another embodiment is directed to a method according to certain embodiments of the invention, wherein the barrier film is heated to a temperature of approximately 100° C. Another embodiment is directed to a method according to certain embodiments of the invention, wherein the barrier film is baked for approximately one hour at approximately 100° C.

Another embodiment is directed to a method according to certain embodiments of the invention, wherein the press fit assembly is part of a disc drive system.

Another embodiment is directed to a method according to certain embodiments of the invention, wherein the components are pressed using a press force whose amplitude may vary widely, but is preferably of less than 300 lbf, more preferably less than 250 lbf, more preferably less than 225 lbf, more preferably less than 200 lbf, more preferably less than 165 lbf.

Another embodiment is directed to a method according to certain embodiments of the invention, wherein there is no measurable ripple or oscillation of force over a 0.2 mm or less displacement while the components are pressed together, wherein the oscillation comprises at least three non-sequential force values over the displacement.

Another embodiment is directed to a method according to certain embodiments of the invention, wherein there is no measurable ripple or oscillation of force over a 0.2 mm or less displacement while the components are pressed together, wherein the oscillation comprises at least four non-sequential force values over the displacement.

Another embodiment is directed to a method according to certain embodiments of the invention, wherein there is no measurable ripple or oscillation of force over a 0.4 mm or less displacement while the components are pressed together, wherein the oscillation comprises at least three non-sequential force values over the displacement.

Another embodiment is directed to a method according to certain embodiments of the invention, wherein the barrier film prevents migration of oils or lubricants.

Another embodiment is directed to a method according to certain embodiments of the invention, wherein there is minimal or no cleaning of the components of the press fit assembly after the pressing.

Another embodiment is directed to a hub and shaft assembly, wherein the hub and the shaft are coupled together according to the methods of embodiments of the present invention.

Another embodiment of this invention is directed to a press fit assembly comprising a hub and a shaft, and a surface altering barrier film between one or more areas of the hub and the shaft which are in contact with each other. In another embodiment, this assembly further comprises a portion of the shaft which is in contact with an oil to facilitate rotation about a vertical axis. In another embodiment, this assembly further comprises a blocking barrier film on an intermediate area of the shaft adjacent to the portion of the shaft which is in contact with the oil, wherein the blocking barrier film prevents migration of the oil to other areas of the assembly.

Another embodiment is directed to an assembly comprising a barrier film which comprises, fluorocarbon, a fluorochemical acrylate polymer coating, a hydrofluoroether solvent, polyethylene, polytetrafluoroethylene, polyvinylidene chloride, polyvinylidene fluoride, ethylene-vinyl alcohol copolymer, metals, aluminum, silicon oxide or silicon dioxide, ethylene, chlorotrifluoroethylene copolymer, polychlorotrifluoroethylene polymer, or a combination thereof.

Another embodiment is directed to an assembly comprising a barrier film, wherein the barrier film repels fluids, air or gases. Another embodiment is directed to an assembly comprising a barrier film, wherein the barrier film is impermeable to fluids and wherein the fluids comprise lubricating oils, silicones, hydrocarbon oils, silicone oils, synthetic fluids, aqueous solutions, heptane, toluene, water, or combinations thereof. Another embodiment is directed to an assembly, wherein the fluids bead and drain from the area to which the barrier film is applied.

Another embodiment is directed to an assembly comprising a barrier film, wherein the barrier film is insoluble in heptane, toluene, water, or combinations thereof.

Another embodiment is directed to an assembly comprising a barrier film, wherein the barrier film is strippable with fluorinated solvents.

Another embodiment is directed to an assembly comprising a barrier film, wherein the barrier film is transparent.

Another embodiment is directed to an assembly comprising a barrier film, wherein the barrier film has a refractive index of 1.5 or less.

Another embodiment is directed to an assembly comprising a barrier film, wherein the barrier film has minimal or no toxicity.

Another embodiment is directed to an assembly comprising a barrier film, wherein the barrier film has a soft modulus of elasticity.

Another embodiment is directed to an assembly comprising a barrier film, wherein the barrier film has a surface energy that can vary widely but is preferably of less than 35 dynes/cm, more preferably 12 dynes/cm or less, and more preferably 11 dynes/cm or less.

Another embodiment is directed to an assembly comprising a barrier film, wherein the barrier film has a thickness that may vary but is preferably of less than 0.2 microns, and more preferably of less than 0.1 micron.

Another embodiment is directed to an assembly comprising components, wherein one or more of the components are metal, copper, aluminum, ceramic, steel, tin, glass, or combinations thereof.

Another embodiment is directed to an assembly according to embodiments of this invention, wherein the assembly is part of a disc drive system.

Other embodiments and advantages of the invention are set forth in part in the description, which follows, and in part, may be obvious from this description, or may be learned from the practice of the invention.

### DESCRIPTION OF THE DRAWINGS

FIG. 1 is an illustrative drawing of a disc drive comprising several parts that have been press fit together in accordance with some embodiments of the invention.

FIG. 2 is a chart and 2 graphs that illustrate problems with the prior art. Data obtained while press fitting a hub to a shaft under “dry” conditions, as acquired during experimentation conducted to achieve embodiments of the present invention, demonstrate that press fitting under dry conditions required high press forces.

FIG. 3 is a chart and 2 graphs that illustrate problems with the prior art. Data obtained while press fitting a hub to a shaft while using isopropyl alcohol as a lubricant, as acquired during experimentation conducted to achieve embodiments of the present invention, demonstrate that press fitting using alcohol produced undesired choppiness in addition to requiring high press forces.

FIG. 4 is a chart and 4 graphs that present data obtained while press fitting a hub to a shaft while using barrier film as a surface altering agent, in accordance with some embodiments of the invention.

FIG. 5 is a chart and 2 graphs that present data obtained while press fitting a hub to a shaft while using “cured” barrier film as a surface altering agent, in accordance with some embodiments of the invention.

### DESCRIPTION OF THE EMBODIMENTS OF THE INVENTION

Current problems capable of being surprisingly solved by embodiments of the present invention include the contamination of adjacent parts with oils or other lubricating fluids. Current problematic designs also result in very high Press Forces or pronounced Force/Displacement “ripple” or “chatter,” problems which can also surprisingly be eliminated with embodiments of the current invention. Embodiments of the present invention allow for a barrier film to act in place of a lubricant during the hub-shaft press operation, but require no press operator application or clean-off after press. Moreover, barrier film is often applied to other areas of the hub and shaft anyway; thus, it can easily be applied as a surface altering agent and cured to the press fit areas at the same time pursuant to certain embodiments of the invention.

As embodied and broadly described herein, the present invention is directed to barrier films for parts lubrication in hub to shaft press fit operations. Current designs of hub to shaft press fit result in either very high press forces (for example under dry conditions, without any lubrication, but also under other current designs), contamination of adjacent parts (for example from use of oil as a lubricant or from the oils in other parts of the device), or pronounced force/displacement “ripple” or chatter (for example, when alcohol is used as a lubricant). These characteristics are undesirable because certain forces may be outside of the range of the press. Furthermore, current designs and methods of press fitting may result in damaging or deforming the parts. It was surprisingly discovered that applying a surface altering agent such as an electronic coating which forms a barrier film to the hub bore and shaft (in the press fit area), and, preferably in certain embodiments, curing it at an ambient temperature and in some embodiments preferably baking it, would allow a reduction in press force and an elimination of force/displacement “ripple” or chatter. Moreover, there would be no contamination of adjacent parts with oils or a clean-off requirement after a press operation.

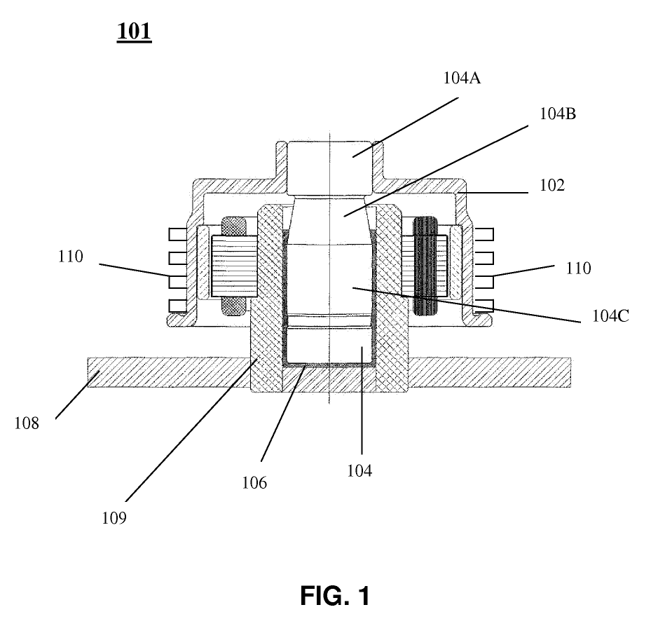

FIG. 1 depicts a disc drive comprising several parts which have been press fit together in accordance with some embodiments of the invention. In FIG. 1, a disc drive 101 comprises a hub 102, a shaft 104, and several other parts. The lower portion of shaft 104, the fluid dynamic bearing portion 104C, rests in oil 106 to facilitate rotation about the vertical axis. The oil 106 serves as a fluid dynamic bearing between the sleeve 109 and the dynamic bearing portion of the shaft 104C. The sleeve 109 is fixed to the base 108, which is also fixed. The upper portion of shaft 104, the press fit portion 104A has been press fit into a corresponding portion of hub 102. The diameter of shaft 104 varies from one end to the other end, but is approximately 6 millimeters (mm) at its maximum diameter. The outside diameter of hub 102 is approximately 24 mm. The portion of hub 102 intended to be joined with shaft 104 is approximately 15 microns smaller in diameter than the diameter of the corresponding portion of shaft 104. This 15 micron difference in diameter results in retention strength between these two parts after they have been pressed together. This retention strength is desired so that hub 102 and shaft 104 rotate together during operation of the disc drive, relative to the fixed sleeve 109 and base 108. The media or discs 110 are secured to the rotating hub 102 and spin with it. This 15 micron difference also results in the need for a significant press force to press these two parts together. The press force varies with the lubricant and can be between approximately 500-600 pounds-feet (lbf) when no lubricants or undesired lubricants are used, and in some embodiments of this invention be approximately 200 lbf when a barrier film acts as a surface altering agent. The magnitude of this press force requires the use of a machine to accomplish the hub to shaft press fit operation. One example of a machine suitable for this purpose is the Janome Electro Press.

Barrier film-forming coatings can be applied to the intermediate portion of the shaft 104B to prevent contamination of discs 110 by bearing oil 104. This substantially prevents oil, a lubricant, from entering and contaminating the region where the disc is located or from the press fitting junction. Thus, barrier film can be used to prevent unwanted lubrication materials from contacting certain parts. However, it was surprisingly discovered that use of a barrier film as a surface altering agent could substantially eliminate many of the disadvantages associated with conventional press force methods, such as contamination of adjacent parts, ripple, and a requirement of very high press forces. In accordance with some embodiments of the invention, a surface altering agent which forms a barrier film pursuant to embodiments of this invention is first applied to the portions of the hub 102 and shaft 104, for example, 104A which will be in contact with each other during the press fit operation. However, embodiments of this invention are directed to any press fit, not just disc drives.

Barrier films provide surprising and significant advantages over other traditional barriers and lubricants. For example, fluid migration barriers can change surface characteristics of metal surfaces by filling capillaries and by preventing wetting in certain embodiments. Oil not only can contaminate adjacent parts, but will also bead rather than migrate over the surface onto which it is applied. Thus, barrier films offer surprisingly stark improvements over lubricants such as oil.

In the disc drive field, embodiments of this invention are directed to methods for assembling fluid dynamic bearing motors in which a shaft has three portions: (1) a press fit junction; (2) an isolation/transition portion; and (3) a fluid dynamic bearing portion submerged in oil. In some embodiments of this invention, the barrier film is applied to portions (1) and (2) of the device, while portion (3) is submerged in oil that acts as a lubricant and that must be isolated from the discs.

The barrier film may be applied as a liquid state surface altering agent which subsequently dries or is preferably cured by baking to form a barrier film. In certain embodiments, the barrier film solution may be cured at 60° C. or more; preferably, the curing is carried out at 70° C. or more, more preferably at 80° C. or more, more preferably at 90° C. or more, more preferably at between 90° C. or more, most preferably at 100° C. or more. The barrier film may preferably be applied using any suitable method such as dipping the parts into the barrier film, brushing the barrier film onto the parts, and/or spraying the barrier film onto the parts. The barrier film used in embodiments of the invention include fluorocarbon films such as 3M™ Novec™ electronic coatings and NyeBar® films (water-vapor permeable plastic films), and can be applied in accordance with embodiments of the present invention or in the form received from the manufacturer. In certain embodiments, no additional preparation is required. Barrier film characteristics include clear appearance, low viscosity of the solution, low toxicity, flexibility, strength and fluid-impermeability (the fluid may be, for example, ink, printable liquid for writing media, air, oil, or gasses). Barrier films can comprise, for example, fluorochemical acrylate polymer coatings carried in a hydrofluoroether solvent or other solvents. Solvents preferably have a boiling point of approximately between 50° and 60° Celsius. Barrier films can also comprise polyethylene, polytetrafluoroethylene, polyvinylidene chloride, polyvinylidene fluoride, ethylene-vinyl alcohol copolymer, metal films such as aluminum, silicon oxide or silicon dioxide, ethylene, chlorotrifluoroethylene copolymer, polychlorotrifluoroethylene polymer, and CVD diamond-like coated films (where CVD refers to a chemical vapor deposition process).

In certain embodiments, the barrier films do not contain any volatile organic compounds (VOCs). In some embodiments, the barrier films can be applied to clean, moisture-free surfaces such as copper, aluminum, ceramic, steel, tin or glass. Barrier films may be used on MR recording heads, spindle motors, head gimbal assemblies, MEMS, CRTs and LCDs. In embodiments, the barrier film solution dries into an ultra-thin (preferably approximately 0.1 micron thickness) transparent or nearly transparent film with excellent anti-wetting, anti-stiction, anti-migration, and anticorrosion properties. Preferably, the refractive index of dry barrier film in certain embodiments is approximately 1.38. Barrier films may have low surface energy (in some embodiments, less than 35 dynes/cm, in some embodiments, less than 30 dynes/cm, or less than 20 dynes/cm, or more preferably 11-12 dynes/cm) to repel liquids such as lubricating oils, hydrocarbon oils and silicones and silicone oils, synthetic fluids and aqueous solutions. The barrier film solutions can form clear, nearly invisible, uniform film that is insoluble in solvents such as heptane, toluene and water, and additionally preferably repel these solvents as well as liquids having low surface tension values such as lubricating oils and silicones, for example, which bead and drain freely from the barrier film surface without adversely affecting the physical and chemical properties of the film. In certain embodiments, barrier films may appear colorless to light-colored in their liquid solution form before drying. Barrier films may contain approximately 0.2% solids and have a specific gravity of 1.5 at 25° C. They can be strippable with fluorinated solvents. They can endure up to 175° Celsius, and in some embodiments preferably greater than 175° C., for prolonged periods and maintain good repellency (for example, in certain embodiments, the barrier film is repellant to chlorinated silicone oil after 24 hours at 175° C.). Barrier films of certain embodiments of this invention are inflammable and environmentally safe. See 3M™ Novec™ Electronic Coating EGC-1702 product information, for example.

The barrier film solution or surface altering agent in liquid form dries at room/ambient temperature in embodiments of this invention, preferably in less than 5 minutes, more preferably in less than 3 minutes, more preferably in less than 2 minutes, and most preferably in approximately 1 minute or less. In certain embodiments, the barrier film solution or the already partially or completely dried barrier film is cured by baking at temperatures of greater than 60°, greater than 70°, greater than 80°, greater than 90°, or more preferably at approximately 100° C. or more. The baking can be carried out for approximately 30 minutes or more, more preferably at 45 minutes or more, and most preferably for approximately one hour or more. The additional baking has shown, in certain embodiments, to improve the lubricating properties of the barrier film as exhibited by lowered press forces needed to press fit components of an assembly together (for example, press forces of approximately 250 lbf or less, or preferably press forces of approximately 200 lbf or less). Curing of the barrier film solution at ambient temperatures can, nevertheless, in certain embodiments, lower the press force required for press fit operations to approximately 200 lbf or less, more preferably to approximately 170 lbf or less, more preferably to approximately 160 lbf or less.

The following examples illustrate embodiments of the invention, but should not be viewed as limiting the scope of the invention.

### EXAMPLES

The results of the embodiments of the invention have been quantified by measuring the press force required to press a hub and shaft together under varying conditions. The force (in pounds-feet [lbf]) was measured as a function of displacement (in millimeters) of the hub and shaft as these parts were being gradually joined together through a press, under various conditions including current conditions under the prior art and embodiments of the present invention.

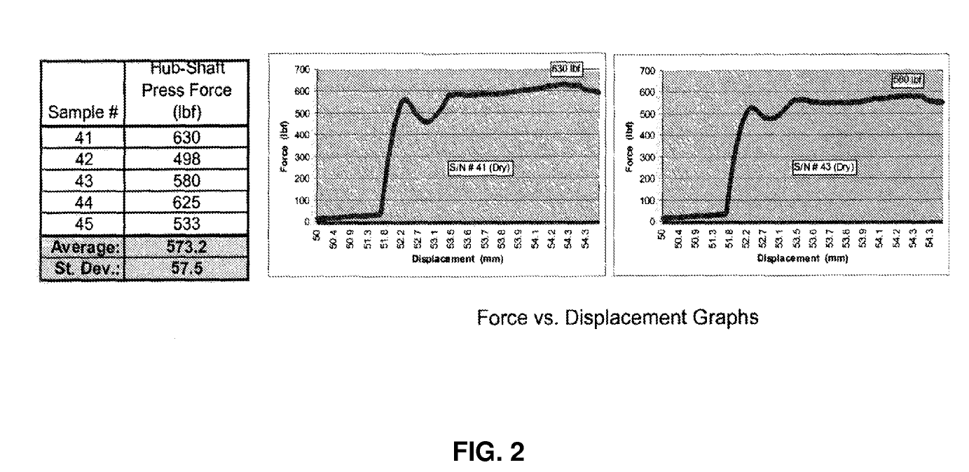

The first experiment entailed pressing a hub and shaft together using a mechanical press without applying a lubricating agent between the surfaces of these two parts (also referred to herein as the “dry” condition). FIG. 2 is a chart and two graphs which summarize the force required to press a hub to a shaft under “dry” conditions, without lubricant and without barrier film. The chart on the left side of FIG. 2 shows the press forces required during five separate operations of pressing a hub to a shaft. Using the force data measured during operations, the average required force was computed to be 573.2 pound-feet (lbf), with a standard deviation of 57.5 lbf. FIG. 2 also includes force vs. displacement graphs for 2 of the 5 samples tested, which show a considerable spike (of approximately 500 lbf) in the force required to join the hub and shaft together at after about 1.8 mm of displacement. Subsequently, a further increase in the required press force of about another 100 lbf is needed to finish the press fit operation under dry conditions.

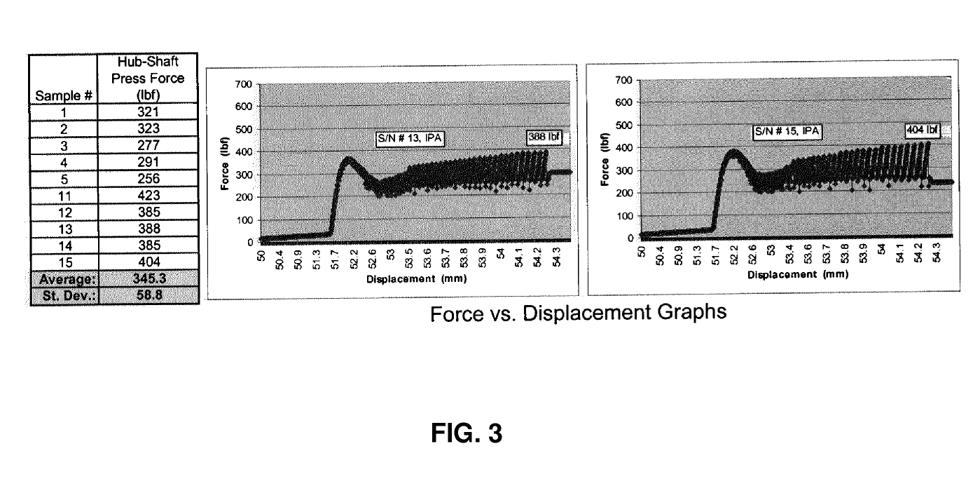

The second experiment entailed pressing a hub and shaft together using a mechanical press with isopropyl alcohol as a lubricant. FIG. 3 depicts a chart and two graphs that present data obtained during this experiment. Under these conditions, the isopropyl alcohol was applied just prior to each press fitting operation. The chart on the left side of FIG. 3 shows the press force values obtained from ten separate operations of pressing a hub to a shaft. The average required force was computed to be 345.3 pound-feet (lbf) (with a standard deviation of 58.8 lbf), which was lower than the press force required under dry conditions. However, additional problems surfaced under this experiment, as can be seen from the FIG. 3 force vs. displacement graphs for 2 of the 10 samples in the chart. In these two graphs, a sudden increase of about nearly 400 lbf in the press force requirement to displace the parts of the press fit operation after approximately 1.7 mm of displacement. The additional problematic occurrence during press fitting using isopropyl alcohol was the observable “ripple” or chatter, which constitutes pronounced vacillation in the press force. This ripple phenomenon is caused by jerky motion of the hub on the shaft, and is undesirable because it exerts excessive stress on the press and can therefore damage various parts of the press including the shaft. Furthermore, ripple causes difficulty in pressing the parts to a prescribed or desired height or position due to the surging motion during the operation, preventing the setting of the height axially with precision.

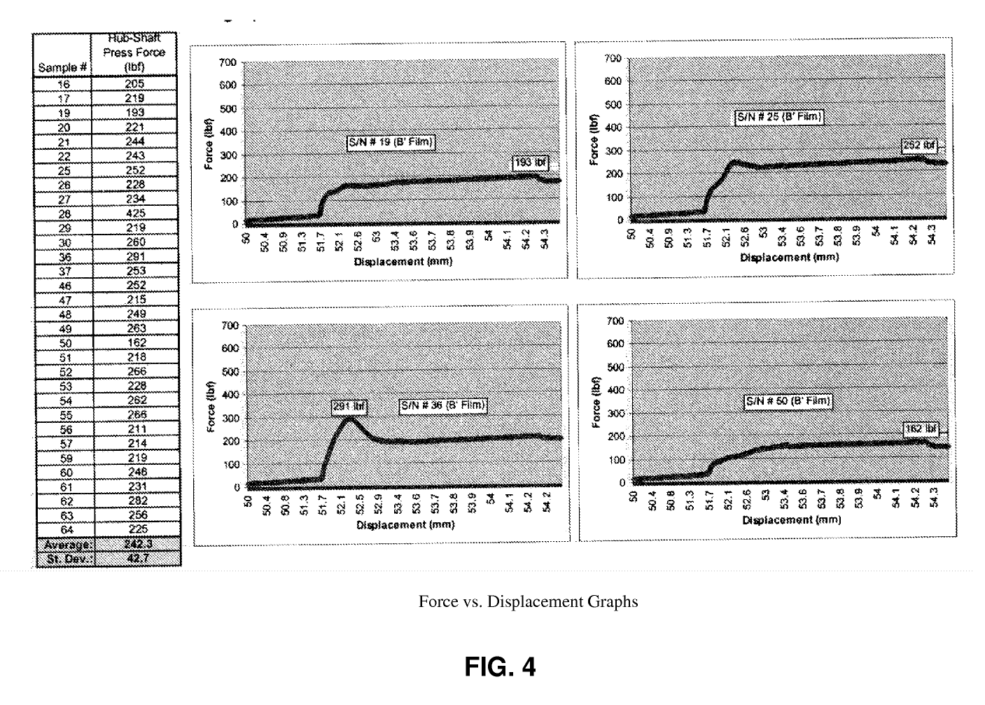

The third experiment entailed press fitting a hub to a shaft while using barrier film as a surface altering agent, in accordance with some embodiments of the invention. FIG. 4 depicts a chart and four graphs that present data obtained in this experiment. Barrier film (P/N 100171563, 3M™ Novec™ ECG-1702 0.2% (an often clear, low viscosity solution of fluorochemical acrylate polymer coating carried in a hydrofluoroether solvent) was applied to the hub bore and shaft in the press fit area only, and cured at ambient temperature. The hub and shaft were pressed together without isopropyl alcohol which would degrade the barrier film. The chart on the left side of FIG. 4 shows the press force data obtained from thirty-two separate operations of pressing a hub to a shaft. Using the force data measured during operations, the average required force was computed to be 242.3 pound-feet (lbf) with a standard deviation of 42.7 lbf. This significantly lower force than that required under dry conditions or using isopropyl alcohol is due to the use of the barrier film, which was the surprisingly effective variable of this experiment. FIG. 4 also includes force vs. displacement graphs for four of the thirty-two samples in the chart. From these graphs, it can be seen that after about 1.7 mm of displacement, a much smaller increase in press force is required to complete the press fit operation under embodiments of this invention as compared to dry or isopropyl alcohol conditions: preferably a spike of merely approximately 150-200 lbf, or more preferably 100-150 lbf, is observed, as compared to 500-600 lbf as seen in the FIG. 2 charts for dry press fitting. Furthermore, no ripple or chatter was observed during these tests, as had occurred under isopropyl alcohol press fitting conditions evident from the FIG. 3 charts.

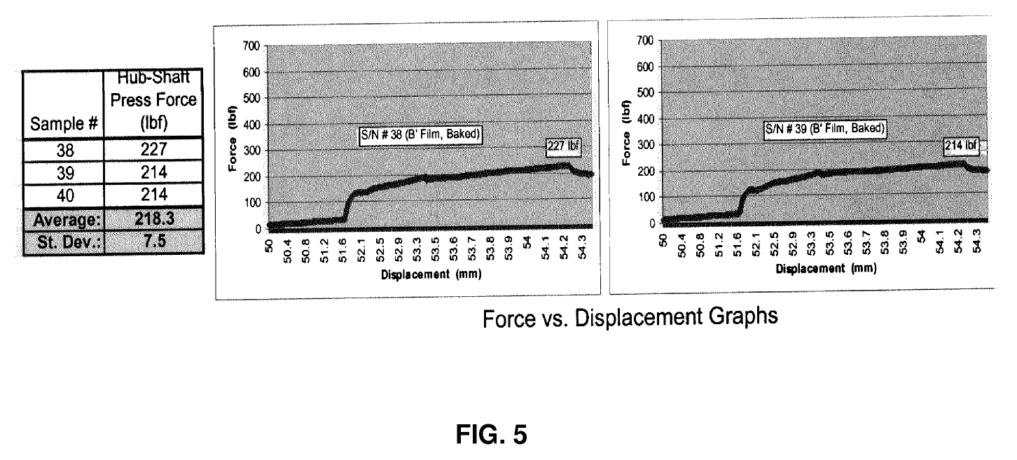

The fourth experiment entailed press fitting a hub to a shaft while using “cured” barrier film as a surface altering agent, in accordance with some embodiments of the invention. FIG. 5 depicts a chart and two graphs that present data obtained in this experiment. Barrier film (P/N 100171563, 3M™ Novec™ ECG-1702 0.2%) was applied to the hub bore and shaft in the press fit area only at an ambient temperature and then baked at 100° Celsius for one (1) hour prior to each press fitting operation. The hub and shaft were pressed together without isopropyl alcohol. The chart on the left side of FIG. 5 shows press force data obtained from three separate operations of pressing a hub to a shaft. Using the force data measured during operations, the average required force was computed to be 218.3 pound-feet (lbf), with a standard deviation of 7.5 lbf. The average press force was, evidently, reduced even lower than in the non-cured barrier film experiments. FIG. 5 also includes force vs. displacement graphs for two of the three samples in the chart. From these graphs, it can be seen that after about 1.6 mm of displacement, a much smaller increase in press force is required to complete the press fit operation under the cured barrier film embodiments of this invention as compared to dry conditions, isopropyl alcohol lubricated conditions, and even the non-cured barrier film conditions of this invention: preferably, a spike of less than 100 lbf is seen after less than 2 mm displacement for a total of less than 230 lbf over the course of the entire press fit operation; preferably less than a total of 220 lbf press force is required; more preferably, less than 215 lbf press force is required. Furthermore, besides the decrease in press force required for press fitting with cured barrier film, no force/displacement ripple or chatter is experienced as occurred when isopropyl alcohol was used.

The data in the above discussed figures show that the press force required to press a hub to a shaft is lowered when barrier film is used as a surface altering agent during these operations. Adding the step of baking the barrier film at 100° Celsius after applying the film to the parts and prior to the press fitting operation further reduces the required press force. Thus, the data from these two barrier film test conditions illustrate the advantages of the present invention over conventional methods such as dry pressing without lubricant or applying isopropyl alcohol: lower press force; elimination or reduction of force vs. displacement ripple; prevention of contamination of adjacent parts and elimination of post-press clean-off.

Other embodiments and uses of this invention will be apparent to those skilled in the art from consideration of the specification and practice of the invention disclosed herein. All references cited herein, for any reason, are specifically and entirely incorporated by reference. The specification and examples should be considered exemplary only within the true scope and spirit of the invention.

1. A method of securely joining components of a press fit assembly comprising:
applying a surface altering agent to a surface area of a first component that is to be placed in contact with a second surface area of a second component within the press fit assembly, and wherein the surface altering agent forms a barrier film; and
pressing the surface area containing the barrier film into contact with the second surface area.

2. The method of claim 1, wherein the barrier film forming comprises:
applying the surface altering agent in a liquid form to the first surface area; and
drying the liquid form surface altering agent at room temperature.

3. The method of claim 1, wherein the barrier film forming comprises:
applying the surface altering agent in a liquid form to the first surface area; and
drying the liquid form surface altering agent at a temperature of greater than 25° C., greater than 40° C., greater than 60° C., greater than 80° C., greater than 95° C., or greater than 100° C.

4. The method of claim 1, wherein the surface altering agent at least one of fills capillaries of the surface area to which it is applied and prevents wetting of the surface area to which it is applied.

5. The method of claim 1, wherein the surface altering agent comprises a fluorochemical acrylate polymer coating carried in a hydrofluoroether solvent that evaporates, fluorocarbon, fluorochemical acrylate polymer substance, a hydrofluoroether solvent, polyethylene, polytetrafluoroethylene, polyvinylidene chloride, polyvinylidene fluoride, ethylene-vinyl alcohol copolymer, metals, aluminum, silicon oxide, silicon dioxide, ethylene, chlorotrifluoroethylene copolymer, polychlorotrifluoroethylene polymer, or a combination thereof.

6. The method of claim 1, wherein the barrier film repels fluids, air or gases.

7. The method of claim 1, wherein the barrier film is insoluble in heptane, toluene, water, or combinations thereof and the barrier film is strippable with fluorinated solvents.

8. The method of claim 1, wherein one or more of the components are copper, aluminum, ceramic, steel, tin, glass, or combinations thereof.

9. The method of claim 1, further comprising at least one of heating the barrier film before pressing the parts together, heating the barrier film to a temperature of approximately 100° C., and baking the barrier film for approximately one hour.

10. The method of claim 1, wherein the barrier film prevents migration of oils or lubricants.

11. The method of claim 1, wherein there is minimal or no cleaning of the components of the press fit assembly after the pressing.

12. A hub and shaft assembly, wherein the hub and the shaft are coupled together according to the method of claim 1.

13. A press fit assembly comprising a hub and a shaft, and a surface altering barrier film between one or more areas of the hub and the shaft which are in contact with each other.

14. The assembly of claim 13, further comprising a portion of the shaft which is in contact with an oil to facilitate rotation about a vertical axis.

15. The assembly of claim 13, further comprising a blocking barrier film on an intermediate area of the shaft adjacent to the portion of the shaft which is in contact with the oil, wherein the blocking barrier film prevents migration of the oil to other areas of the assembly.

16. The assembly of claim 13, wherein the barrier film comprises, fluorocarbon, a fluorochemical acrylate polymer coating, a hydrofluoroether solvent, polyethylene, polytetrafluoroethylene, polyvinylidene chloride, polyvinylidene fluoride, ethylene-vinyl alcohol copolymer, metals, aluminum, silicon oxide or silicon dioxide, ethylene, chlorotrifluoroethylene copolymer, polychlorotrifluoroethylene polymer, or a combination thereof.

17. The assembly of claim 13, wherein the barrier film repels fluids, air or gases.

18. The assembly of claim 13, wherein the barrier film is insoluble in heptane, toluene, water, or combinations thereof and the barrier film is strippable with fluorinated solvents.

19. The assembly of claim 13, wherein one or more of the components are copper, aluminum, ceramic, steel, tin, glass, or combinations thereof.

20. A method of securely joining components of a press fit assembly comprising:
applying a surface altering agent to a surface area of a first component that is to be placed in contact with a second surface area of a second component within the press fit assembly, and wherein the surface altering agent forms a barrier film;
pressing the surface area containing the barrier film into contact with the second surface area;
applying the surface altering agent in a liquid form to the first surface area; and
drying the liquid form surface altering agent at room temperature.
